(19) United States
(12) Patent Application Publication
(10) Pub. No.: US 2021/0286443 A1
(43) Pub. Date: Sep. 16, 2021

(54) CHARACTER INPUT DEVICE, CHARACTER INPUT METHOD, AND CHARACTER INPUT PROGRAM STORED ON COMPUTER-READABLE STORAGE MEDIUM

(71) Applicant: OMRON Corporation, Kyoto-shi (JP)

(72) Inventor: Mieko YAMAUCHI, Kusatsu-shi (JP)

(73) Assignee: OMRON Corporation, Kyoto-shi (JP)

(21) Appl. No.: 17/176,205

(22) Filed: Feb. 16, 2021

(30) Foreign Application Priority Data
Mar. 12, 2020 (JP) 2020-042600

(51) Int. Cl. G06F 3/023; G06K 9/34

(52) U.S. Cl. CPC G06F 3/0237; G06K 2209/01; G06K 9/344; G06F 3/0236

(57) ABSTRACT

A character input device according to one or more embodiments may include a controller and a database. The database may store a normal predictive conversion suggestion, a function name, and a function setting module associated with the function name. The controller may include a suggestion controller and a display controller. The suggestion controller may obtain a function setting symbol for enabling the function setting module in response to the reading of a character at least partially matching the function name. The display controller may display the function setting symbol obtained by the suggestion controller together with the normal predictive conversion suggestion.

### CROSS-REFERENCE TO RELATED APPLICATION

This application claims priority to Japanese Patent Application No. 2020-042600 filed on Mar. 12, 2020, the contents of which are incorporated herein by reference.

### FIELD

The disclosure relates to a technique for enabling a user to perform function settings associated with an input.

### BACKGROUND

Japanese Unexamined Patent Application Publication No. 2013-254259

(“Patent Literature 1”) describes a Chinese character (kanji) converter. The kanji converter described in Patent Literature 1 stores category information indicating an attribute of each application program. The kanji converter described in Patent Literature 1 determines the order of conversion suggestions to appear based on the category information.

### SUMMARY

However, known kanji converters described in, for example, Patent Literature 1, do not allow function settings for operations including a key operation to be performed easily. Also, the manner of activating the function settings with the known kanji converters is not easily found.

One or more embodiments may be directed to a technique for allowing function settings for operations including a key operation to be performed easily.

A character input device according to one or more embodiments may have the structure described below.

A database may store a normal predictive conversion suggestion, a function name, and a function setting module associated with the function name. A suggestion controller may detect a reading of an input character and detects matching between the reading of the input character and the normal predictive conversion suggestion. A display controller may display the normal predictive conversion suggestion detected by the suggestion controller on a display screen. The suggestion controller may obtain a function setting symbol for enabling the function setting module in response to the reading of the input character at least partially matching the function name. The display controller may display the function setting symbol obtained by the suggestion controller together with the normal predictive conversion suggestion.

In above described arrangement, in response to an input of a Japanese hiragana character (reading of a character string) relevant to a function setting, the function setting symbol for enabling the function setting may appear on the display screen. Selecting the function setting symbol may allow a user to shift to the function setting and perform the function setting.

The suggestion controller included in the character input device may obtain and output, to the display controller, a function setting image in response to selection of the function setting symbol. The display controller may display the function setting image. The controller may enable the function setting module.

The display controller included in the character input device may display the function setting symbol at a position different from the normal predictive conversion suggestion on the display screen. The display controller included in the character input device may display the function setting symbol at a predetermined position on the display screen. The display controller included in the character input device may display the function setting symbol in an emphasized manner.

A character input device according to one or more embodiments may allow function settings for operations including a key operation to be performed easily.

### BRIEF DESCRIPTION OF THE DRAWINGS

FIG. 1 is a block diagram illustrating a character input device according to one or more embodiments.

FIG. 2 is a diagram illustrating an example display with a character input method according to a first embodiment.

FIG. 3 is a diagram illustrating a flowchart of the character input method according to a first embodiment.

FIG. 4 is a diagram illustrating an example display with a character input method according to a second embodiment.

FIG. 5 is a diagram illustrating an example display with a character input method according to a third embodiment.

### DETAILED DESCRIPTION

One or more embodiments are described with reference to the drawings.

### Example Use

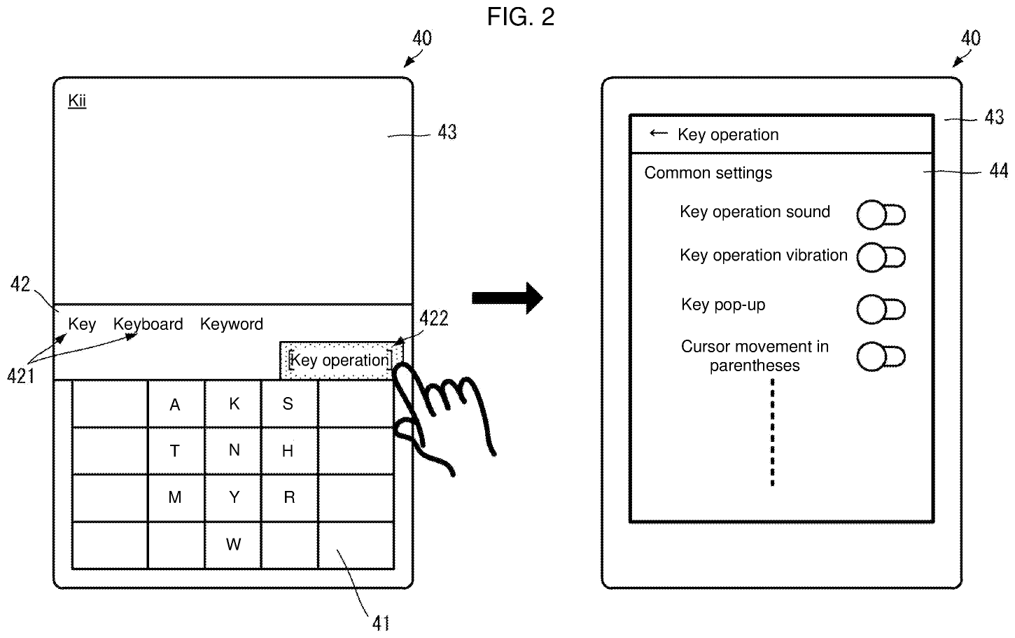

FIG. 2 is a diagram illustrating an example display with a character input method according to a first embodiment.

A user (character inputter) inputs Japanese hiragana characters (reading of a character string) relevant to an intended character string by operating a keypad display area 41 on a display 40. The display 40 includes a character display area 43 displaying input characters and a suggestion display area 42 displaying a function setting symbol 422 together with normal predictive conversion suggestions 421 for the input characters.

In response to the user selecting the function setting symbol 422, a function setting image of a function setting module 511 corresponding to the function setting symbol 422 appears on a display screen in a predetermined display pattern. In the example shown in FIG. 2, the function setting image appears in the suggestion display area 42.

The user performs an operational input with the function setting image to set a function.

In the example shown in FIG. 2, the function setting symbol 422 is Key Operation, and the function is the setting for key operations. As shown in the left part of FIG. 2, in response to the user inputting Japanese hiragana characters (e.g., Kii) relevant to function settings, Key Operation appears as the function setting symbol 422. In response to selection of the function setting symbol 422 of Key Operation, a function setting image 44 appears as shown in the right part of FIG. 2. The user performs an operational input with the function setting image 44 to perform the settings for key operations.

The user can thus easily perform the function settings. The user can also easily find the manner of performing function setting including shifting to the function setting image.

### Structure

### First Embodiment

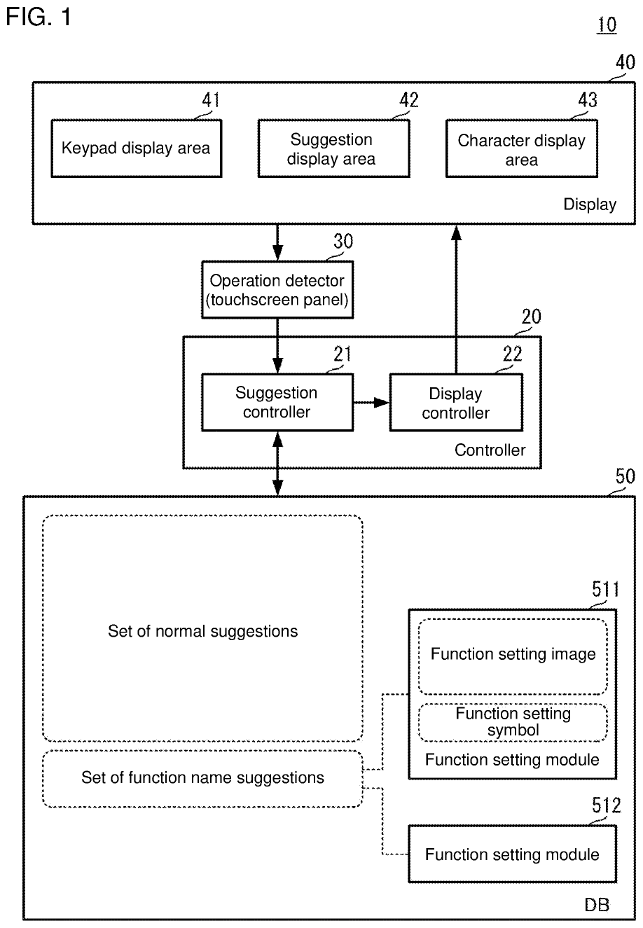

A character input technique according to a first embodiment will be described with reference to the drawings. FIG. 1 is a functional block diagram illustrating a character input device according to one or more embodiments. As described above, FIG. 2 is a diagram illustrating an example display with a character input method according to a first embodiment.

As shown in FIG. 1, a character input device 10 includes a controller 20, an operation detector 30, the display 40, and a database 50. The character input device 10 is implemented by, for example, a mobile information processing terminal.

The controller 20 includes a suggestion controller 21 and a display controller 22. The processing performed by the controller 20 will be described later in detail.

The display 40 includes the keypad display area 41, the suggestion display area 42, and the character display area 43. As shown in FIG. 2, the keypad display area 41, the suggestion display area 42, and the character display area 43 are, for example, located on the display screen of the display 40. The keypad display area 41 displays various keys for inputting characters. The suggestion display area 42 displays, for example, conversion suggestions and a symbol (button) detected with a method described later. The character display area 43 displays characters input with the keypad display area 41 and an input character string.

More specifically, the operation detector 30 is, for example, a touchscreen panel included in the display 40, and detects an operational input into the display 40, or in other words, an operation on the keypad display area 41, the suggestion display area 42, and the character display area 43. The operation detector 30 outputs the operation to the suggestion controller 21 in the controller 20. The operation detector 30 uses a known method for detecting an operation, which will not be described in detail.

The database 50 stores normal predictive conversion suggestions as a set of normal suggestions. The database 50 stores a set of function name suggestions. The database 50 also stores function setting modules 511 and 512. Each of the function setting modules 511 and 512 is stored in a manner associated with the corresponding function name. For example, a function setting module for a key setting is stored in a manner associated with the function name of Key Setting.

The function setting modules 511 and 512 each include a function setting image and a function setting symbol. For example, the function setting image for a key operation setting image and the function setting symbol for Key Operation are stored in a manner associated with the function setting module for Key Setting. The function setting image is an image appearing on the display screen to receive a user operational input (for entering) (corresponding to a setting screen that receives an input for causing an executable file to perform predetermined processing). The input information is detected by the operation detector 30 and transmitted to the executable file that performs processing in accordance with the input information.

Although the function setting modules 511 and 512 may each include an executable file for function settings, the executable file may be stored in, for example, a storage medium separate from the database 50.

The character input device 10 with the above structure detects and displays the normal predictive conversion suggestions and allows a function setting input in the manner described below.

In response to the user (character inputter) operating the keypad display area 41 to input Japanese hiragana characters (reading of a character string), the operation detector 30 detects this character input operation and outputs the operation to the suggestion controller 21.

The suggestion controller 21 detects the reading of the input characters based on the detection result of the operational input. The suggestion controller 21 outputs the detected reading to the display controller 22. The display controller 22 displays the reading in the character display area 43.

The suggestion controller 21 uses the detected reading to detect and obtain normal predictive conversion suggestions in the set of normal suggestions at least partially matching the detected reading.

The suggestion controller 21 also detects a function name at least partially matching the reading. In response to detection of the function name, the suggestion controller 21 refers to the function setting module associated with the function name and obtains the function setting symbol included in the function setting module.

The suggestion controller 21 outputs the obtained conversion suggestions in the set of normal suggestions and the obtained function setting symbol to the display controller 22.

The display controller 22 displays, in the suggestion display area 42, the normal predictive conversion suggestions 421 in the set of normal suggestions and the function setting symbol 422 (refer to the left part of FIG. 2). The display controller 22 may display the function setting symbol 422 at a predetermined position in the suggestion display area 42. The function setting symbol 422 at a predetermined position allows the user to view the function setting symbol 422 more easily.

When the suggestion controller 21 detects selection of a normal predictive conversion suggestion 421 in the set of normal suggestions based on the detection result from the operation detector 30 detecting an operation on the suggestion display area 42, the suggestion controller 21 outputs the selected normal predictive conversion suggestion 421 to the display controller 22. The display controller 22 outputs the selected normal predictive conversion suggestion 421, instead of the reading, to the character display area 43. This enters the conversion based on the normal predictive conversion suggestions.

When the suggestion controller 21 detects selection of the function setting symbol 422 based on the detection result from the operation detector 30 detecting an operation on the suggestion display area 42, the suggestion controller 21 obtains the function setting image associated with the function setting symbol 422. The suggestion controller 21 outputs the obtained function setting image to the display controller 22.

The display controller 22 displays the function setting image on the display screen of the display 40, instead of the normal predictive conversion suggestions 421 and the function setting symbol 422 (refer to the right part of

FIG. 2).

The controller 20 performs a function setting using the detection result from the operation detector 30 detecting an operation at a predetermined position on the function setting image. The setting is reflected to enter the function corresponding to the setting.

With the structure and method according to the present embodiment, the user can easily shift to the function settings through a conversion suggestion process typically performed for a character input, without using a known method that cannot be found easily.

In the example shown in FIG. 2, in response to the user inputting

Japanese hiragana characters Kii, the character display area 43 in the display 40 displays the Japanese hiragana characters Kii (yet to be entered). The suggestion display area 42 then displays the function setting symbol 422 Key Operation associated with key operation settings together with the normal predictive conversion suggestions 421, such as Key, Keyboard, and Keyword, for the Japanese hiragana characters Kii (refer to the left part of FIG. 2).

In this state, in response to the user selecting the function setting symbol Key Operation, the suggestion display area 42 displays an image for setting key operations, which is a function setting image associated with key operations (refer to the right part of FIG. 2).

Thus, the user can obtain a chance to shift to the function settings for key operations by simply inputting, for example, Japanese hiragana characters Kii for key operations, which is an example function setting. The user can thus easily perform the function settings for key operations.

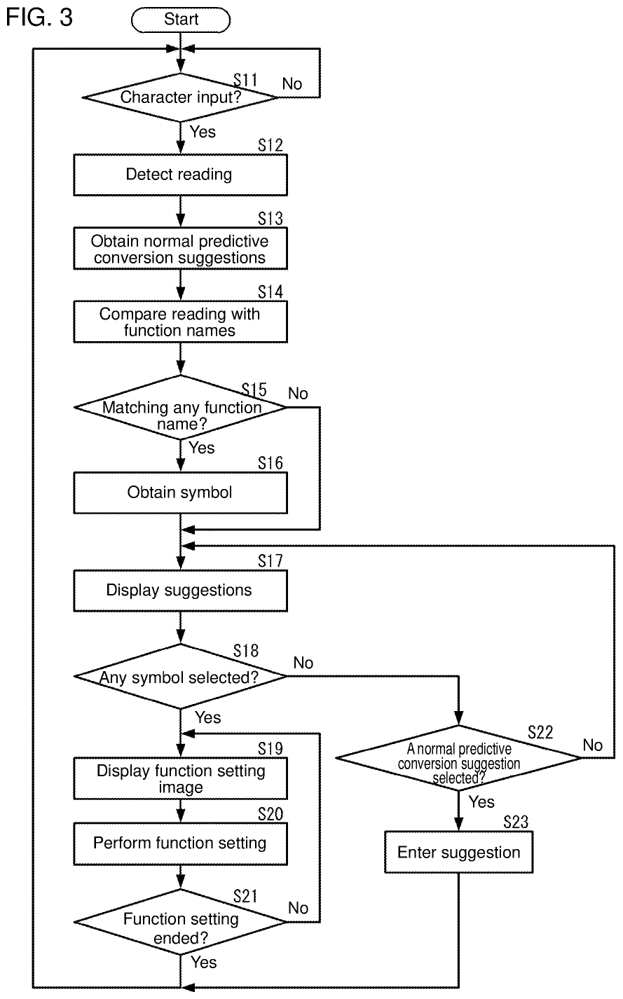

To perform the above processing, the controller 20 in the character input device 10 performs, for example, the procedure shown in FIG. 3. FIG. 3 is a flowchart showing the character input method according to a first embodiment. FIG. 3 simply shows processing characteristic of the one or more embodiments, without showing detailed processing associated with the characteristic processing or processing that may be known with any known character conversion process.

As shown in FIG. 3, in response to an input of Japanese hiragana characters (reading of a character string) (Yes in S11), the controller 20 detects the reading (S12). The controller 20 maintains an input standby state until receiving an input of Japanese hiragana characters (reading of a character string) (No in S11).

The controller 20 obtains normal predictive conversion suggestions matching the reading (S13). The controller 20 compares the reading with the function names (S14).

In response to the reading matching any of the function names (Yes in S15), the controller 20 obtains the function setting symbol associated with the function name (S16). Matching herein may be perfect matching, partial matching, matching of a front portion, or matching of a rear portion. The controller 20 that has obtained the function setting symbol then displays the function setting symbol together with the normal predictive conversion suggestions (S17). In response to the reading matching no function name (No in S15), the controller 20 simply displays the normal predictive conversion suggestions (S17).

In response to selection of the function setting symbol (Yes in S18), the controller 20 obtains and displays the function setting image (S19). The controller 20 activates an executable file for the function settings. The executable file herein performs the function settings in a conversion process in response to an input of a character(s). The executable file thus enables the function settings in an application that performs an input process in response to an input of a character(s). An external application for the function settings may be invoked as the executable file for the function settings.

The controller 20 performs the function settings in accordance with an operational input into the function setting image (S20). The controller 20 continues the function settings until an operational input is performed for ending the function settings (No in S21). In response to the operational input for ending the function settings (Yes in S21), the controller 20 returns to a normal character input state (S11).

In response to selection of a normal predictive conversion suggestion (Yes in S22) without selection of any function setting symbol (No in S18), the controller 20 enters the selected normal predictive conversion suggestion (S23) and returns to the normal character input state (S11). The controller 20 remains displaying the normal predictive conversion suggestions and the function setting symbol until the normal predictive conversion suggestion is selected (No in S22).

### Second Embodiment

A character input technique according to a second embodiment displays a function setting symbol in a manner different from the character input technique according to a first embodiment. The other components associated with the character input technique according to a second embodiment are the same as for the character input technique according to a first embodiment and will not be described.

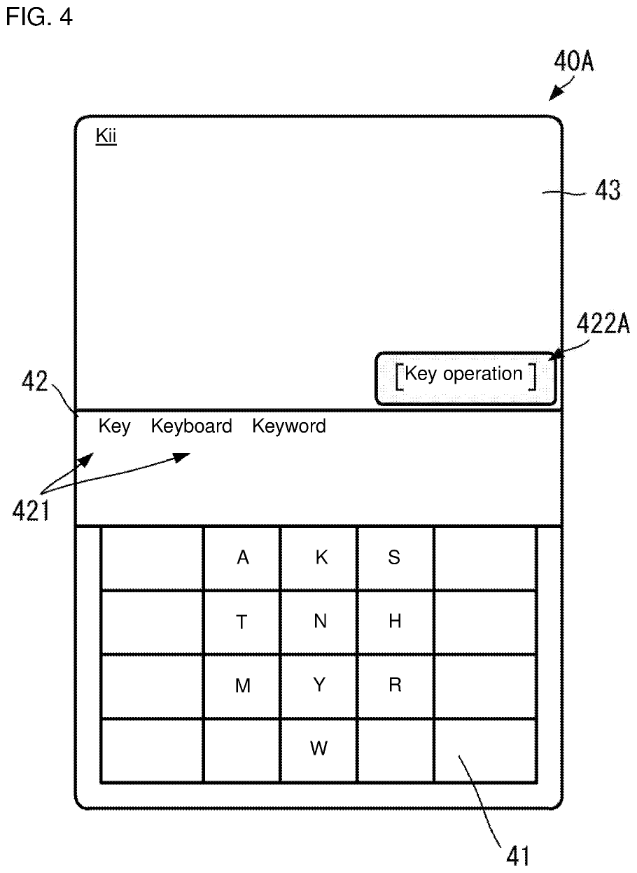

FIG. 4 is a diagram illustrating an example display with a character input method according to a second embodiment.

In the second embodiment, as shown in FIG. 4, a function setting symbol 422A appears at a position different from the suggestion display area 42 on a display screen of a display 40A. In the example shown in FIG. 4, the function setting symbol 422A appears outside and immediately above the suggestion display area 42.

The suggestion display area 42 thus displays the normal predictive conversion suggestions 421 alone. In other words, although the function setting symbol 422A is obtained, the number of normal predictive conversion suggestions 421 to appear on the suggestion display area 42 may not be reduced.

This structure allows easy shifting to function settings, while allowing a normal conversion process to be performed in the same manner as in a known structure without using a function setting symbol.

### Third Embodiment

A character input technique according to a third embodiment differs from the character input technique according to a first embodiment in that a function setting symbol appears in an emphasized manner. The other components associated with the character input technique according to a third embodiment are the same as for the character input technique according to a first embodiment and will not be described.

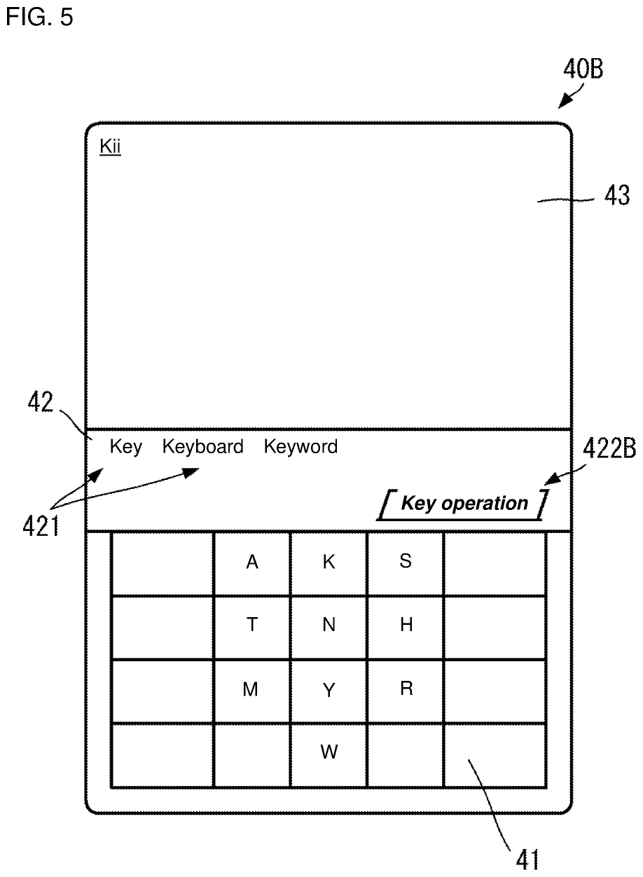

FIG. 5 is a diagram illustrating an example display with a character input method according to a third embodiment.

In the third embodiment, as shown in FIG. 5, a function setting symbol 422B appears on a display screen of a display 40B in an emphasized manner. Appearing in an emphasized manner refers to, for example, appearing in bold, appearing with a font different from the font for normal predictive conversion suggestions, and appearing with italics. Any emphasized manner may be used for displaying the function setting symbol differently from normal predictive conversion suggestions.

This allows the user to view the function setting symbol more easily.

The database 50 is included in an information processing terminal in the above embodiments. However, the database 50 may be located externally to the information processing terminal, for example, on a network. The suggestion controller 21 in the controller 20 may also be at least partially located externally to the information processing terminal (e.g., on a network).

The function setting symbol according to one or more embodiments may appear in manners other than with brackets or emphasized in bold, italics, and a different font as described above. For example, the function setting symbol may be an image of an icon, or more specifically, any image that appears differently from the normal predictive conversion suggestions and presents the shifting to the function settings to the user.

The above structures and methods according to one or more embodiments may be combined as appropriate to produce advantageous effects depending on each combination.

### Appendix

A character input device for inputting a character according to one or more embodiments may include: a database storing a normal predictive conversion suggestion, a function name, and a function setting module associated with the function name; and a controller including a suggestion controller configured to detect a reading of an input character and detect matching between the reading of the input character and the normal predictive conversion suggestion, and a display controller configured to display the normal predictive conversion suggestion detected by the suggestion controller on a display screen, wherein the suggestion controller obtains a function setting symbol for enabling the function setting module in response to the reading of the input character at least partially matching the function name, and the display controller displays the function setting symbol obtained by the suggestion controller together with the normal predictive conversion suggestion.

The suggestion controller may obtain and outputs, to the display controller, a function setting image in response to selection of the function setting symbol, the display controller may display the function setting image, and the controller enables the function setting module.

The display controller may display the function setting symbol at a position different from the normal predictive conversion suggestion on the display screen.

The display controller may display the function setting symbol at a predetermined position on the display screen.

The display controller may display the function setting symbol in an emphasized manner.

1. A character input device for inputting a character, the device comprising:
a database storing a normal predictive conversion suggestion, a function name, and a function setting module associated with the function name; and
a controller comprising a suggestion controller configured to detect a reading of an input character and detect matching between the reading of the input character and the normal predictive conversion suggestion, and a display controller configured to display the normal predictive conversion suggestion detected by the suggestion controller on a display screen, wherein
the suggestion controller obtains a function setting symbol for enabling the function setting module in response to the reading of the input character at least partially matching the function name, and
the display controller displays the function setting symbol obtained by the suggestion controller together with the normal predictive conversion suggestion.

2. The character input device according to claim 1, wherein
the suggestion controller obtains and outputs, to the display controller, a function setting image in response to selection of the function setting symbol,
the display controller displays the function setting image, and
the controller enables the function setting module.

3. The character input device according to claim 1, wherein
the display controller displays the function setting symbol at a position different from the normal predictive conversion suggestion on the display screen.

4. The character input device according to claim 1, wherein
the display controller displays the function setting symbol at a predetermined position on the display screen.

5. The character input device according to claim 1, wherein
the display controller displays the function setting symbol in an emphasized manner.

6. A character input method for detecting, with a computer, a conversion suggestion for an input character, the method comprising:
detecting a reading of the input character;
detecting matching between the reading of the input character and a function name stored in a database;
obtaining a function setting symbol in a function setting module associated with the function name in response to the reading of the input character at least partially matching the function name; and
displaying the function setting symbol together with a normal predictive conversion suggestion on a display screen.

7. A non-transitory computer-readable storage medium storing a character input program for causing a computer to detect a conversion suggestion for an input character, which when read and executed, causes the computer to perform operations comprising:
detecting a reading of the input character;
detecting matching between the reading of the input character and a function name stored in a database;
obtaining a function setting symbol in a function setting module associated with the function name in response to the reading of the input character at least partially matching the function name; and
displaying the function setting symbol together with a normal predictive conversion suggestion on a display screen.

8. The character input device according to claim 2, wherein
the display controller displays the function setting symbol at a position different from the normal predictive conversion suggestion on the display screen.

9. The character input device according to claim 2, wherein
the display controller displays the function setting symbol at a predetermined position on the display screen.

10. The character input device according to claim 3, wherein
the display controller displays the function setting symbol at a predetermined position on the display screen.

11. The character input device according to claim 2, wherein
the display controller displays the function setting symbol in an emphasized manner.

12. The character input device according to claim 3, wherein
the display controller displays the function setting symbol in an emphasized manner.

13. The character input device according to claim 4, wherein
the display controller displays the function setting symbol in an emphasized manner.
